(19) United States
(12) Patent Application Publication
(10) Pub. No.: US 2022/0234612 A1
(43) Pub. Date: Jul. 28, 2022

(54) LOCATION INDICATOR DEVICES

(71) Applicant: Hewlett-Packard Development Company, L.P., Spring, TX (US)

(72) Inventors: Jonathan Munir Salfity, Palo Alto, CA (US); Amalendu Iyer, Palo Alto, CA (US); Hiroshi Horii, Palo Alto, CA (US); Mithra Vankipuram, Palo Alto, CA (US); Ji Won Jun, Palo Alto, CA (US)

(73) Assignee: Hewlett-Packard Development Company, L.P., Spring, TX (US)

(21) Appl. No.: 17/611,306

(22) PCT Filed: Sep. 25, 2019
(86) PCT No.: PCT/US2019/052867

§ 371 Date: Nov. 15, 2021

(51) Int. Cl. B60W 60/00; G06F 3/01; G05D 1/00

(52) U.S. Cl. CPC B60W 60/005; B60W 2540/225; G05D 1/0011; G06F 3/013

(57) ABSTRACT

In one example, a location indicator device can include a location identifier to identify an area that is proximate to the location indicator device, and a transmitter to: send the identified area to an autonomous robotic device, and send instructions to the autonomous robotic device to alter a direction from a different area to the identified area.

### BACKGROUND

Autonomous robotic devices can be utilized to perform functions without human interaction. For example, an autonomous robotic vacuum can be utilized to vacuum a floor surface of an area without direct human interaction. In some examples, the autonomous robotic device can include instructions to determine a navigation path for the area based on sensors interacting with a plurality of obstacles such that the autonomous robotic device can navigate the area around the plurality of obstacles.

### BRIEF DESCRIPTION OF THE DRAWINGS

FIG. 1 is an example system for a location indicator device consistent with the present disclosure.

FIG. 2 is an example system for a location indicator device consistent with the present disclosure.

FIG. 3 is an example autonomous robotic device consistent with the present disclosure.

FIG. 4 is an example system for a location indicator device consistent with the present disclosure.

### DETAILED DESCRIPTION

In some examples, autonomous robotic devices can be utilized to perform functions without direct human interaction. For example, an autonomous robotic device can include a controller that is communicatively coupled to a plurality of sensors that can be utilized to detect obstacles, objects, and/or boundaries of an area to generate a navigation path through the area. In some examples, the autonomous robotic device may not rely on constant or semi-constant direction from a user. For example, the user may not have to utilize a joystick or controller to change the direction of the autonomous robotic device to turn or alter the direction of the autonomous robotic device. That is, the autonomous robotic device can be activated and navigate through an area without a user having to direct the autonomous robotic device to avoid obstacles, objects, and/or boundaries of the area.

As described herein, the autonomous robotic device can generate a navigation path utilizing sensor data and/or area data associated with a particular area. In some examples, the autonomous robotic device can utilize feedback from the sensors to update the navigation path, For example, the autonomous robotic device can make contact with a surface at a location within the area and utilize a contact sensor to determine that an obstruction exists at the location within the area. In this example, the autonomous robotic device can utilize the location of the obstruction to update the navigation path to move in a direction around the obstruction. In some examples, the autonomous robotic device can utilize the sensors to dynamically update the navigation path without direct interaction from the user. However, the technique of utilizing the sensors to dynamically update a navigation path to navigate an area can result in portions of the area being missed or avoided.

The present disclosure relates to location indicator devices that can be utilized with an autonomous robotic device. In some examples, the location indicator devices can be utilized to identify an area of interest that can be provided to the autonomous robotic device. In these examples, the autonomous robotic device can receive the identified area of interest from the location indicator and alter a navigation path based on the identified area of interest.

In some examples, the location indicator device can be utilized to identify a perimeter of an area to instruct the autonomous robotic device to alter a behavior (e.g., navigation path, etc.) to perform a function within the perimeter of the area. In some examples, the autonomous robotic device can include a docking interface to couple the location indicator to a surface of the autonomous robotic device. In this way, the location indicator device can be removed from the autonomous robotic device to indicate the area of interest and alter the behavior of the autonomous robotic device based on the indicated area.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

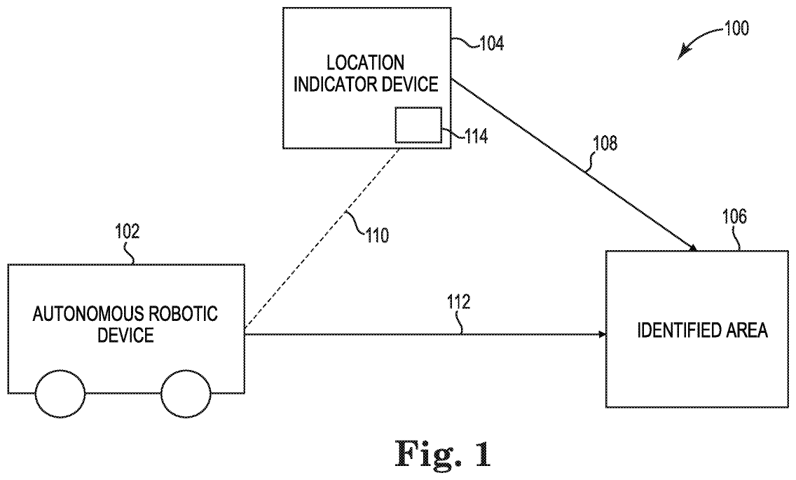

FIG. 1 is an example system 100 for a location indicator device 104 consistent with the present disclosure. In some examples, the system 100 can be positioned within a particular area (e.g., room, particular floor of a building, etc.). As described herein, the system 100 can include a location indicator device 104 that can be utilized with an autonomous robotic device 102 to identify a specific area (e.g., identified area 106, etc.). In some examples, the identified area 106 can be a portion of the particular area. In some examples, the identified area 106 can be an area that was previously missed by the autonomous robotic device 102. For example, the autonomous robotic device 102 can perform a particular function and the autonomous robotic device 102 may not have performed the particular function at the identified area 106.

In some examples, the autonomous robotic device 102 can be a mechanical device that can include a mechanical system to mechanically move the autonomous robotic device 102 from a first location to a second location. For example, the autonomous robotic device 102 can include motorized wheels, motorized tracks, motorized legs, and/or or other type of mechanical system that can move the autonomous robotic device 102 from a first location to a second location.

In some examples, the mechanical system to move the autonomous robotic device 102 from a first location to a second location can be communicatively coupled to a controller. In some examples, the controller can be a computing device that is physically proximate to the autonomous robotic device 102 or a computing device that is physically remote from the autonomous robotic device 102. For example, the autonomous robotic device 102 can include a controller positioned within an enclosure of the autonomous robotic device 102. In another example, the autonomous robotic device 102 can be connected to a network that communicatively couples the autonomous robotic device 102 to a remote controller or computing device.

In some examples, the controller can be utilized to navigate the mechanical system of the autonomous robotic device 102. For example, the controller can be utilized to generate a navigation path or a behavior of the autonomous robotic device 102. As used herein, a behavior can include a function that is performed by the autonomous robotic device 102. For example, the behavior of the autonomous robotic device 102 can include settings that alter how a function is performed, a navigation path of the autonomous robotic device 102, and/or other settings that alter a performance of the autonomous robotic device 102. As used herein, a navigation path includes instructions for navigating an area utilizing sensor feedback, sensor data, and/or area data to avoid obstacles. In some examples, the controller can utilize contact sensors, infrared sensors, radio frequency sensors, and/or other sensors to identify obstacles, objects, and/or barriers within the area. For example, the controller can be coupled to a contact sensor such that the controller can receive an indication when the autonomous robotic device 102 makes physical contact with an object within the area. In this example, the controller can utilize the sensor data to update the behavior of the autonomous robotic device 102 to avoid the identified object. In a similar way, the controller can utilize other types of sensor data to identify obstacles, objects, and/or barriers within the area to navigate around the area.

In some examples, the sensor data can be stored to be utilized by the controller during future use of the autonomous robotic device 102. For example, the controller can utilize the sensor data to generate a first navigation path for the autonomous robotic device 102 to navigate a particular area. In this example, the first navigation path can be specific for the particular area since the sensor data can correspond to the particular area. In some examples, the autonomous robotic device 102 can receive additional sensor data when executing the first navigation path and generate a second navigation path based on the additional sensor data. In this way, the autonomous robotic device 102 can more efficiently navigate the particular area each time the autonomous robotic device 102 navigates the particular area.

In other examples, a behavior such as a suction level of a vacuuming function can be altered for an identified area based on the surface features of the identified area. In these examples, the autonomous robotic device 102 can perform vacuuming functions for an area and the location indicator device 104 can be utilized to select a particular behavior to be utilized when performing the function within the identified area 106. For example, the identified area 106 can be a rug. In this example, the location indicator device 104 can instruct the autonomous robotic device 102 to lower a suction level of a vacuuming function when the autonomous robotic device 102 is within the identified area 106.

In some examples, a portion of the particular area may be missed or avoided based on the sensor data. In some examples, the portion of the particular area can be identified by the location indicator device 104. For example, the location indicator device 104 can be utilized to determine an identified area 106. In this example, the identified area 106 can be a portion of the particular area that is missed or avoided by the autonomous robotic device 102.

In some examples, a visually projected indicator 108 can be an emitted light source to provide visual feedback of an identified perimeter of the identified area 106. In some examples, the location indicator device 104 can be utilized to identify a perimeter of the identified area 106. For example, the location indicator device 104 can include a projected indicator (e.g., non-visual indicator, etc.) or visually projected indicator 108 to identify a perimeter of the identified area 106. In this example, the visually projected indicator 108 can include a laser or other type of projected emission to allow a user to visually identify the identified area 106 that is identified by the location indicator device 104. In some examples, the visually projected indicator 108 can include a dot or line image that can be utilized to move along the perimeter of the identified area 106. In other examples, the visually projected indicator 108 can include an adjustable shape that can be adjusted to a particular size to identify the perimeter of the identified area 106. For example, the visually projected indicator 108 can be a projected box shape or rectangle shape that can be increased or decreased in size to the size of the identified area 106. In this example, the projected shape can be adjusted to the size of the identified area 106 and the adjusted projected shape can be captured by the location indicator device 104. As used herein, capturing the identified area 106 can include storing data associated with the identified area 106. In some examples, capturing or storing the data associated with the identified area 106 can include a particular location of the location indicator device 104, an angle of the location indicator device 104 when the data is captured, and/or other data that can be utilized by the autonomous robotic device 102 to determine the geographical location of the identified area 106.

In some examples, the location indicator device 104 can include an image capturing device to identify the identified area 106 based on an angle of the image and perimeter of the image. For example, the location indicator device 104 can include a camera that can capture an image of the identified area 106. In this example, the camera can include a mechanism to determine an angle of the camera at the time the image was captured. In this example, the edges or perimeter of the image can correspond to the perimeter of the identified area 106. Thus, the image capturing device can be utilized to capture the area data as described herein. As described herein, an angle of the location indicator device 104 and/or an angle of the camera at the time the image was captured can be determined and utilized by the autonomous robotic device 102 to determine the geographic position of the identified area 106. For example, the autonomous robotic device 102 can utilize triangulation or other type of calculation to determine the geographic location of the identified area 106 based on the location of the location indicator device 104 and an angle of the location indicator device 104 when the data is captured.

In some examples, the location indicator device 104 can be utilized to identify an access area to the identified area 106. As described herein, the autonomous robotic device 102 can utilize sensor data to generate a navigation path to navigate through an area. In addition, the identified area 106 can be an area that is relatively difficult for the autonomous robotic device 102 to access, For example, the identified area 106 can be a corner of an area that includes a plurality of objects or obstacles. In this example, the autonomous robotic device 102 can sense the plurality of objects or obstacles and determine that a navigation path should avoid the identified area 106 to avoid the plurality of objects or obstacles. Due to the process for identifying the objects or obstacles (e.g., using sensor data to identify objects, etc.), the autonomous robotic device 102 may not be able to identify an access area to the identified area 106. As used herein, an access area can include a pathway to an area (e.g., identified area 106, etc.) that is free or substantially free of objects, obstacles, or other features that can prevent the autonomous robotic device 102 from accessing the area. Thus, the location indicator device 104 can capture data related to the access area and transfer the captured data to the autonomous robotic device 102 via a transmitter 114.

In some examples, the location indicator device 104 can utilize similar techniques for identifying the access area. For example, the location indicator device 104 can utilize a visually projected indicator 108 to identify the access area. For example, the location indicator device 104 can project a laser through the access area and capture location information for the access area. In another example, the location indicator device 104 can identify a space between two objects or obstacles to identify the access area. For example, the access area can be a path between two objects, which may prevent the autonomous robotic device 102 from identifying the access area to the identified area 106. In this example, the location indicator device 104 can capture data to identify the access area between the two objects and transmit the data to the autonomous robotic device 102 via the transmitter 114. As described herein, the data can include a location of the location indicator device 104, an angle of the location indicator device 104, and/or optical information associated with the location indicator device 104. This type of data can be utilized to determine the geographic position or geographic location of the identified area 106. For example, triangulation can be utilized to determine the geographic position of the identified area 106 based on a geographic position of the location indicator device 104, the angle of the location indicator device 104, and/or optical adjustments made to alter the perimeter of the identified area 106 as described herein,

In some examples, the location indicator device 104 can utilize a visually projected shape or line length that can be adjusted to identify the access area. For example, the location indicator device 104 can project a laser line that can be adjusted to a particular size of the access area. In this example, the location and size of the access area can be captured as access area data and transmitted to the autonomous robotic device 102 via the transmitter 114,

As described herein, the location indicator device 104 can be utilized to capture data related to the identified area 106. In some examples, the captured data related to the identified area 106 can be utilized to help the autonomous robotic device 102 navigate to the identified area 106. For example, the location indicator device 104 can capture the data related to the identified area 106 and utilize a transmitter 114 to send the captured data to the autonomous robotic device 102 through a communication path 110. In some examples, previous navigation instructions or navigation path can be overridden by updated navigation instructions or navigation path of the autonomous robotic device 102 to prioritize the identified area 106.

As used herein, a transmitter 114 can include a device that is capable of transferring data from a first device to a second device through a communication path 110. For example, the transmitter 114 can be utilized to transfer the captured data related to the identified area 106 (e.g., area data, perimeter data, navigation path data, etc.) from the location indicator device 104 to the autonomous robotic device 102 through the communication path 110. In some examples, the transmitter 114 can be a wireless transmitter (e.g., WIFI transmitter, Bluetooth transmitter, near field communication (NFC) transmitter, etc.) that can wirelessly transfer the captured data related to the identified area 106 to the autonomous robotic device 102 through a wireless communication path 110.

In some example, the autonomous robotic device 102 can receive the captured data from the location indicator device 104 and generate a navigation path 112 that includes the identified area 106. In some examples, the navigation path 112 can be an updated navigation path. For example, the autonomous robotic device 102 can utilize sensor data to generate a first navigation path. In this example, the first navigation path can be dynamically updated based on sensor data or sensor feedback to avoid objects and/or obstacles within the area. In this example, the autonomous robotic device 102 can receive the data related to the identified area 106 from the location indicator device 104. In this example, the autonomous robotic device 102 can generate the navigation path 112 (e.g., second navigation path, etc.) based on the sensor data and the data related to the identified area 106. In this way, the autonomous robotic device 102 can navigate to the identified area 106 and perform a particular function provided by the autonomous robotic device 102 (e.g., vacuum, mopping, cleaning, inspecting, painting, identifying occupants, etc.). As described herein, the identified area 106 can be identified by the location indicator device 104 and the location indicator device 104 can be utilized to select a particular behavior of the autonomous robotic device 102. The behavior can include the navigation path 112 as well as identifying the particular function and/or settings associated with the particular function.

In some examples, the autonomous robotic device 102 can be directed toward the identified area 106 upon receiving the captured data from the location indicator device 104. For example, the autonomous robotic device 102 can be moving in a first direction away from the identified area 106 and upon receiving the captured data from the location indicator device 104, the autonomous robotic device 102 can move in a second direction toward the identified area 106. In other examples, the autonomous robotic device 102 can incorporate the captured data into a current navigation path and when the autonomous robotic device 102 is proximate to the identified area 106, the autonomous robotic device 102 utilize the captured data to navigate to the identified area 106. In this way, the autonomous robotic device 102 can continue to perform a particular function for the area without interrupting the navigation path through the area. This type of interruption can cause other portions of the area to be missed by the autonomous robotic device 102.

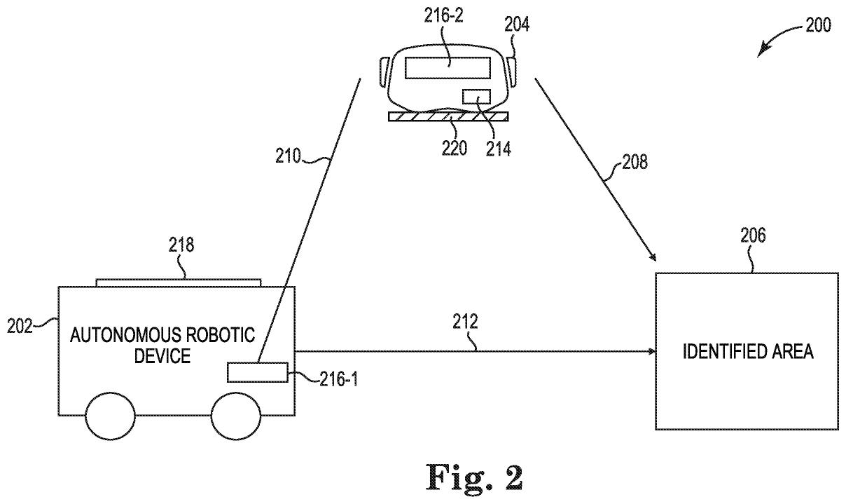

FIG. 2 is an example system 200 for a location indicator device 204 consistent with the present disclosure. In some examples, the system 200 can include the same or similar elements as system 100 as referenced in FIG. 1. For example, the system 200 can include an autonomous robotic device 202 that can utilize sensors to generate a navigation path to navigate around a particular area. In addition, the system 200 can include a location indicator device 204 that can be utilized to capture data related to an identified area 206.

In some examples, the location indicator device 204 can be an altered reality device such as an augmented reality (AR) or virtual reality (VR) device that can be worn by a user. As used herein, an AR device can include a display that can visually enhance or visually alter a real-world area for a user of the device, For example, the AR device can allow a user to view a real-world area while also viewing displayed images by the AR device. As used herein, a VR device can include a display that can generate a virtual area or virtual experience for a user. For example, the VR device can generate a virtual world that is separate or distinct from the real-world location of the user.

In some examples, the location indicator device 204 can be a wearable device that can cover or partially cover the eyes of a user. For example, the location indicator device 204 can include a headset device that can include a display that can be utilized to augment the real-world area of the user. In some examples, the location indicator device 204 can include a controller 216-2. In some examples, the controller 216-2 can be a computing device that can include a processing resource that can execute instructions stored on a memory resource to perform particular functions. In some examples, the controller 216-2 can include instructions to track eye movement of a user wearing the location indicator device 204. For example, the controller 216-2 can be communicatively coupled to an eye tracking sensor. In this example, the eye tracking sensor can provide eye position data to the controller 216-2 and the controller 216-2 can utilize the eye position data to determine where the user is looking relative to the location indicator device 204.

In some examples, the controller 216-2 can utilize the instructions to track eye movement of a user wearing the device to determine the identified area 206 or area of interest. For example, the controller 216-2 can be utilized to determine that a user is looking in the direction of the identified area 206. In this example, the controller 216-2 can receive an indication that the user is looking in the direction and that area data is to be captured related to the identified area 206. As described herein, the location indicator device 204 can capture area data related to the identified area 206. In some examples, the area data can include a direction or angle between the location indicator device 204 and the identified area 206, a perimeter of the identified area 206, and/or an access area that can be utilized by the autonomous robotic device 202 to access the identified area 206.

In some examples, the controller 216-2 can determine an angle between the location indicator device 204 and the identified area 206 within the location and determine an angle between the location indicator device 204 and a current location of the autonomous robot device 202. In some examples, the determined angles can be utilized to determine a location of the location indicator device 204 and a location of the autonomous robotic device 202 relative to the identified area 206.

In some examples, the location indicator device 204 can be directed toward the identified area 206 and a display associated with the location indicator device 204 can display a visual projection 208 on the identified area 206. That is, the location indicator device 204 can display the visual projection 208 through an augmented reality or virtual reality display. In some examples, the visual projection 208 can include an indication of a dot, line, and/or shape to allow a user to point at the identified area 206 through the display of the location indicator device 204.

In some examples, the location indicator device 204 can utilize eye tracking to alter the visual projection 208 of the location indicator device 204. For example, the eye tracking can be utilized to alter the size of a dot, line and/or shape displayed on the display of the location indicator device 204. In this example, the eye tracking can be utilized to identify a perimeter of the identified area 206 by moving an eye position to outline the identified area 206. In other examples, the eye tracking can be utilized to alter a shape of the visual projection 208 to a shape or size of the identified area 206. For example, the visual projection 208 can be shaped as a rectangle and the size of the rectangle can be adjusted to an approximate size or perimeter of the identified area 206 utilizing eye tracking. In this example, a user can move their eyes in a first direction to increase a size of the visual projection 208 and move their eyes in a second direction to decrease the size of the visual projection 208. In some examples, the location indicator device 204 can capture the perimeter of the identified area 206 as well as access area data associated with an access area to the identified area 206. As described herein, the access area can be an area between a current position of the autonomous robotic device 202 and the identified area 206.

In some examples, the location indicator device 204 can capture the area data of the identified area 206 in response to a request (e.g., indication that the visual projection is positioned at the identified area 206, etc.). In some examples, the location indicator device 204 can include a selection mechanism to select when the visual projection is positioned at the identified area 206 and/or when the visual projection is positioned at an access area. In this way, the location indicator device 204 can allow a user to capture area data associated with the identified area 206 and/or access area of the identified area 206.

In some examples, area data can be captured by the location indicator device 204 and transmitted to the autonomous robotic device 202 utilizing a transmitter 214. In some examples, the autonomous robotic device 202 can include a receiver that is communicatively coupled to the transmitter 214 through a communication path 210. In some examples, the receiver can be communicatively coupled to a controller 216-1 of the autonomous robotic device 202. As described herein, the autonomous robotic device 202 and/or controller 216-1 can generate a new navigation path 212 that can be based in part on the area data provided by the location indicator device 204. For example, the controller 216-1 can utilize sensor data from navigating through an area and the area data provided by the location indicator device 204 to generate the navigation path 212 that includes the identified area 206. In other examples, the controller 216-1 can alter a behavior of the autonomous robotic device 202 based on the area data provided by the location indicator device 204.

In some examples, the autonomous robotic device 202 can include a docking interface 218 that can be utilized to receive a connection interface 220. In some examples, the docking interface 218 and the connection interface 220 can be corresponding connectors that can be utilized to transfer electrical energy and/or data between the location indicator device 204 and the autonomous robotic device 202. In some examples, the autonomous robotic device 202 can transfer electrical energy to the location indicator device 204 through the docking interface 218 when the connection interface 220 is coupled to the docking interface 218. In some examples, the autonomous robotic device 202 can transfer device information to the location indicator device 204 through the docking interface 218 when the connection interface 220 is coupled to the docking interface 218.

In some examples, the autonomous robotic device 202 can be in an operation mode. As used herein, an operation mode can include a mode of the autonomous robotic device 202 when performing a function associated with the autonomous robotic device 202. For example, the autonomous robotic device 202 can be a vacuum that performs the function of vacuuming an area. In this example, the operation mode can be a mode of the autonomous robotic device 202 when the autonomous robotic device 202 is vacuuming the area. In some examples, the location indicator device 204 can be coupled to the docking interface 218 through the connection interface 220 during the operation mode. In a similar way, the location indicator device 204 can be removed during the operation mode. In these examples, the autonomous robotic device 202 can determine when the location indicator device 204 has been removed from the docking interface 218 and in response, establish the communication path 210 with the location indicator device 204. In some examples, the autonomous robotic device 202 can continue to provide device status or device information to the location indicator device 204 through the communication path 210.

In some examples, the device status or device information can be displayed on the display associated with the location indicator device 204. For example, the device status or device information can include, but is not limited to: battery level of the autonomous robotic device 202, connection strength of communication path 210, operation mode of the autonomous robotic device 202, potential navigation path for the autonomous robotic device 202, among other information that is associated with the autonomous robotic device 202. In some examples, the device information associated with the autonomous robotic device 202 can be displayed while capturing the area information associated with the identified area 206. In some examples, the device information can be utilized to determine when the autonomous robotic device 202 is able to reach the identified area 206. For example, the captured area data can be provided to the autonomous robotic device 202 and the autonomous robotic device 202 can generate a new navigation path 212 that includes the identified area 206. In this example, the autonomous robotic device 202 can provide updated device information to the location indicator device 204 that includes an approximate time that it will take the autonomous robotic device 202 to reach the identified area 206 based on the new navigation path 212.

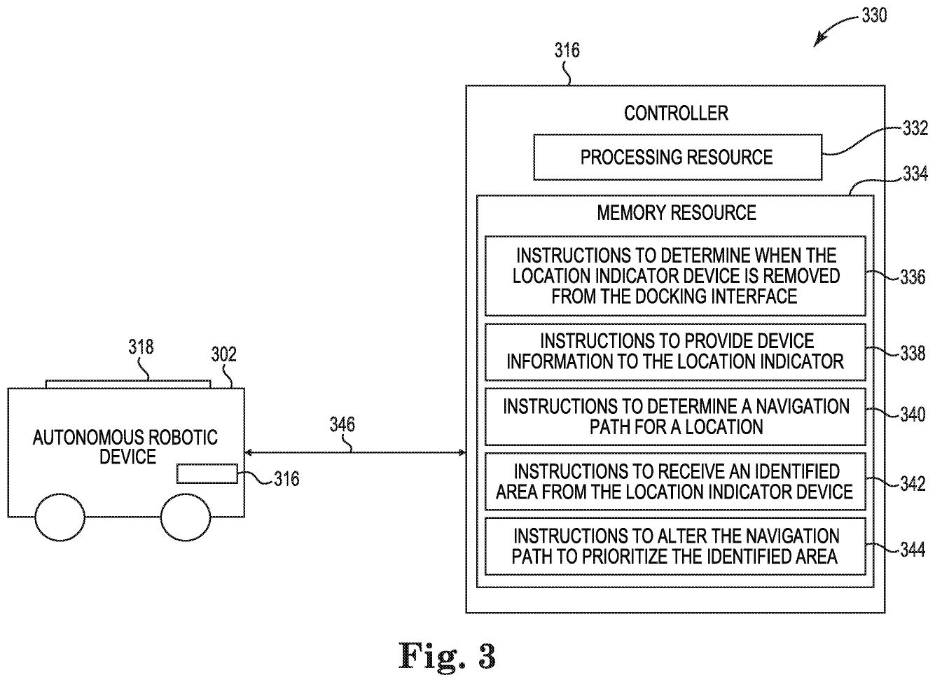

FIG. 3 is an example autonomous robotic device 302 consistent with the present disclosure. In some examples, the autonomous robotic device 302 can be the same or similar device as autonomous robotic device 102 as referenced in FIG. 1 and/or autonomous robotic device 202 as referenced in FIG. 2. For example, the autonomous robotic device 302 can utilize a plurality of sensors to generate a navigation path to perform a function at multiple locations within an area. In this way, the autonomous robotic device 302 can miss portions of the area as described herein.

In some examples, the autonomous robotic device 302 can include a controller 316. In some examples, the controller 316 can be positioned on or within the autonomous robotic device 302. In other examples, the controller 316 can be a remote computing device communicatively coupled to the autonomous robotic device 302 through a communication path 346. In some examples, the autonomous robotic device 302 can include a docking interface 318 that can be utilized to couple a location indicator device to a surface of the autonomous robotic device 302. As described herein, the docking interface 318 can be utilized to transfer electrical energy and/or data to the location indicator device.

In some examples, the controller 316 can be utilized to control particular functions of the autonomous robotic device 302. In some examples, the controller 316 can be connected to the autonomous robotic device 302 through a communication path 346. For example, the controller 316 can be connected to the autonomous robotic device 302 through a wired or wireless communication connection. In some examples, the communication path 346 can be utilized by the controller 316 to generate a navigation path for the autonomous robotic device 302 as described herein. In some examples, the navigation path can be part of a selected or identified behavior to be performed by the autonomous robotic device 302.

In some examples, the controller 316 can include a processing resource 332 and/or a memory resource 334 storing instructions to perform particular functions. A processing resource 332, as used herein, can include a number of processing resources capable of executing instructions stored by a memory resource 334. The instructions (e.g., machine-readable instructions (MRI), computer-readable instructions (CRI), etc.) can include instructions stored on the memory resource 334 and executable by the processing resource 332 to perform or implement a particular function. The memory resource 334, as used herein, can include a number of memory components capable of storing non-transitory instructions that can be executed by the processing resource 332.

The memory resource 334 can be in communication with the processing resource 332 via a communication link (e.g., communication path). The communication link can be local or remote to an electronic device associated with the processing resource 332. The memory resource 334 includes instructions 336, 338, 340, 342, 344. The memory resource 334 can include more or fewer instructions than illustrated to perform the various functions described herein. In some examples, instructions (e.g., software, firmware, etc.) can be downloaded and stored in memory resource 334 (e.g., MRM) as well as a hard-wired program (e.g., logic), among other possibilities. In other examples, the controller 316 can be hardware, such as an application-specific integrated circuit (ASIC), that can include instructions to perform particular functions.

The controller 316 can include instructions 336, that when executed by a processing resource 332 can determine when the location indicator device is removed from the docking interface 318. As described herein, the autonomous robotic device 302 can include a docking interface 318 to electrically and communicatively couple the location indicator device to a surface of the autonomous robotic device 302. In some examples, the autonomous robotic device 302 or controller 316 can determine that the location indicator device has been removed from the docking interface 318. For example, the docking interface 318 can include a sensor pin that is capable of sensing when the location indicator device has been removed. In other examples, the controller 316 can determine that the physical connection between the docking interface 318 and the location indicator device has been disconnected.

The controller 316 can include instructions 338, that when executed by a processing resource 332 can provide device information to the location indicator device. As described herein, the location indicator device can include a display to visually augment reality of a real-world area. The display can be utilized to identify areas of interest and/or areas that were previously missed by the autonomous robotic device 302. In addition, the display can be utilized to display device information related to the autonomous robotic device 302. In some examples, the autonomous robotic device 302 can transfer device information to the location indicator device through the docking interface 318 when the location indicator device is coupled to the docking interface 318. In some examples, the autonomous robotic device 302 can establish a wireless communication path with the location indicator device in response to the location indicator device being removed from the docking interface 318. In these examples, the autonomous robotic device 302 can transfer the device information through the wireless communication path so that the location indicator device includes real time device information that can be displayed to the user through a display.

The controller 316 can include instructions 340, that when executed by a processing resource 332 can determine a navigation path for a location. As described herein, a location can include an area where the autonomous robotic device 302 can perform a function (e.g., vacuuming, mopping, painting, monitoring, etc.). As described herein, a navigation path can be determined or generated by the controller 316 utilizing sensor data to determine a navigation path to avoid objects, barriers, and/or obstacles within the location. In some examples, the navigation path can be dynamically updated utilizing the sensor data. For example, the autonomous robotic device 302 can make contact with an object and receive sensor data related to the object (e.g., object location, etc.). In this example, the autonomous robotic device 302 can dynamically update the navigation path to avoid the object that was contacted.

As described herein, dynamically updating the navigation path based on sensor data can result in the autonomous robotic device 302 missing particular areas. For example, the autonomous robotic device 302 may miss an access area to the particular areas due to objects or obstacles surrounding the access area, which can make it difficult for the autonomous robotic device 302 to identify the particular area. In some examples, the particular area can be identified by a location indicator device as described herein. In some examples, the particular area can be categorized as an identified area when a location indicator device identifies the area.

The controller 316 can include instructions 342, that when executed by a processing resource 332 can receive an identified area from the location indicator device. As described herein, the autonomous robotic device 302 can be communicatively coupled through a communication path when the location indicator device is removed from the docking interface 318. The communication path can be a wireless communication path that can be utilized to send and receive data between the autonomous robotic device 302 and the location indicator device.

The controller 316 can include instructions 344, that when executed by a processing resource 332 can alter the navigation path to prioritize the identified area. As described herein, the navigation path can be dynamically updated through sensor data that is received while the autonomous robotic device 302 is performing a function or navigating through an area. In a similar way, the controller 316 can update or generate a new navigation path upon receiving the area data from the location indicator device. In some examples, the area information provided by the location indicator device can be prioritized over other sensor data received by the autonomous robotic device 302. For example, the autonomous robotic device 302 can determine a more direct path toward the identified area received from the location indicator device and prioritize the identified area over other areas. In this way, a wait time associated with the autonomous robotic device 302 performing a particular function at the identified location can be lowered.

In some examples, the location indicator device can receive a priority level through a user interface displayed on a display associated with the location indicator device. For example, the location indicator device can be utilized to identify a particular area to have the autonomous robotic device 302 perform a function at the identified area. In this example, the location indicator device can determine a priority level for the identified area based on a selection displayed on the display. In some examples, the priority level can be transferred to the autonomous robotic device 302 through a wired or wireless communication path as described herein. The priority level can be utilized by the autonomous robotic device 302 to determine a next behavior for the autonomous robotic device 302. For example, the autonomous robotic device 302 can rank a plurality of behaviors or functions to perform based on the priority level associated with each behavior or function to be performed. In some examples, the autonomous robotic device 302 can rank a plurality of locations to perform a particular function based on a priority level associated with each of the plurality of locations. That is, the autonomous robotic device 302 can rank the plurality of locations based on the priority level and generate a navigation path that sends the autonomous robotic device 302 to relatively higher priority level locations before relatively lower priority level locations.

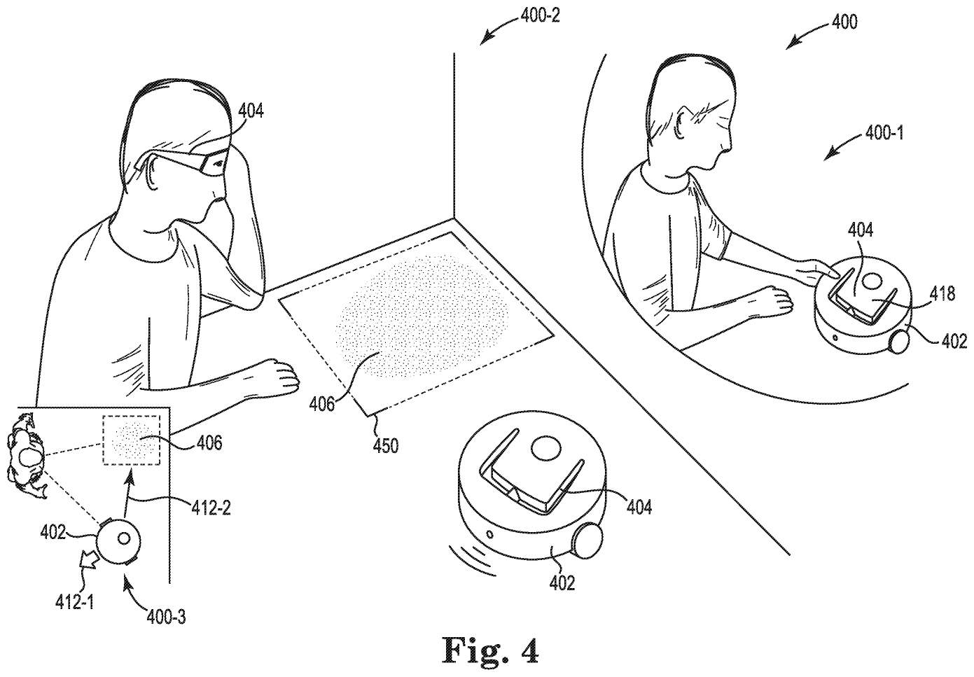

FIG. 4 is an example system 400 for a location indicator device consistent with the present disclosure. In some examples, the system 400 can be a representation of system 100 as referenced in FIG. 1, system 200 as referenced in FIG. 2, and/or utilize an autonomous robotic device 302 as referenced in FIG. 3.

In some examples, the system 400 can be represented by a first system 400-1, a second system 400-2, and/or a third system 400-3 that can represent different aspects of the system 400. For example, the first system 400-1 can illustrate a user docking or undocking a location indicator device 404 to a docking interface 418 of an autonomous robotic device 402. In another example, the second system 400-2 can illustrate a user identifying a perimeter 450 of an identified area 406 utilizing the location indicator device 404. Furthermore, in another example, the third system 400-3 can illustrate an overview of a user utilizing a location indicator device 404 to identify an identified area 406.

In some examples, the first system 400-1 can illustrate that the location indicator device 404 can be a wearable device such as glasses or goggles. In these examples, the glasses or goggles can be utilized to generate an augmented reality of a real-world area. In these examples, the glasses or goggles can utilize a display that can allow a user to view a portion of the area as well as an augmented portion over or on the area. In these examples, the augmented portion may be viewable only to the user of the location indicator device 404. As described herein, the location indicator device 404 can be coupled to a docking interface 418 of the autonomous robotic device 402 to transfer electrical energy and/or data to the location indicator device 404.

In some examples, the second system 400-2 can illustrate a user wearing the location indicator device 404. As described herein, the location indicator device 404 can be glasses that provide an augmented reality to the user. In some examples, the location indicator device 404 can be removed from the docking interface 418 of the autonomous robotic device 402. In these examples, the autonomous robotic device 402 can initiate a communication path with the location indicator device 404 to provide device information to the location indicator device 404. In addition, the communication path can be utilized to transfer captured area data related to an identified area 406 from the location indicator device 404 to the autonomous robotic device 402.

In some examples, the location indicator device 404 can illustrate a projected indicator that can be viewable through the location indicator device 404. In some examples, the projected indicator can be a shape such as a rectangle that can outline the perimeter 450 of the identified area 406. In this way, the location indicator device 404 can identify a portion of an area that may have been missed by the autonomous robotic device 402. For example, the identified area 406 can be a location where a function was not performed by the autonomous robotic device 402. As described herein, the projected indicator can be altered or generated based on eye tracking. For example, the location indicator device 404 can include eye tracking instructions to track the eye movement of a wearer of the location indicator device 404 to identify the identified area 406 and/or capture area data related to the identified area 406.

In some examples, the third system 400-3 can illustrate a top view of a user utilizing the location indicator device 404 to capture area data of the identified area 406. As described herein, the autonomous robotic device 402 can initiate a communication path 410 when the location indicator device 404 is removed from the docking interface 418 of the autonomous robotic device 402. As described herein, the location indicator device 404 can transfer the captured area data to the autonomous robotic device 402 through the communication path 410.

In some examples, the autonomous robotic device 402 can be in an operation mode and utilizing a first navigation path 412-1 moving in a first direction. In these examples, the autonomous robotic device 402 can receive the captured area data from the location indicator device 404 and generate a second navigation path 412-2 that moves the autonomous robotic device 402 in a second direction. As illustrated in the third system 400-3, the first navigation path 412-1 can include a direction that is away from the identified area 406 and the second navigation path 412-2 can include a direction that is toward the identified area 406. That is, the autonomous robotic device 402 can alter direction of a navigation path to move toward an identified area 406 based on the captured area data. In other examples, the captured area data can be provided to the autonomous robotic device 402 to alter a behavior of the autonomous robotic device 402. For example, the altered behavior can include the second navigation path 412-2, a particular function to perform, and/or a plurality of settings associated with the second navigation path 412-2 or particular function to be performed.

The above specification, examples and data provide a description of the method and applications and use of the system and method of the present disclosure. Since many examples can be made without departing from the scope of the system and method of the present disclosure, this specification merely sets forth some of the many possible example configurations and implementations.

What is claimed:

1. A location indicator device, comprising:
a location identifier to identify an area that is proximate to the location indicator device; and
a transmitter to:
send the identified area to an autonomous robotic device; and
send instructions to the autonomous robotic device to alter a behavior of the location indicator device based on the identified area.

2. The location indicator device of claim 1, wherein the location identifier is a wearable device that includes eye tracking to identify the area based on an eye direction.

3. The location indicator device of claim 1, wherein the location identifier is a mobile device that includes a visually projected indicator to identify a perimeter of the area.

4. The location indicator device of claim 3, wherein the visually projected indicator is an emitted light source to provide visual feedback of the identified perimeter of the area.

5. The location indicator device of claim 1, wherein the location identifier includes an image capturing device to identify the area based on an angle of the image and perimeter of the image.

6. The location indicator device of claim 1, comprising a docking interface to couple the location indicator device to the autonomous robotic device, wherein the docking interface receives electrical energy and data from the autonomous robotic device.

7. A system, comprising:
an autonomous robotic device, comprising:
a docking interface to couple a location indicator device to a surface of the autonomous robotic device;
a first controller comprising instructions to autonomously navigate around obstructions within a location; and
the location indicator device, comprising:
an eye tracking mechanism to track an eye gaze of a user;
a second controller comprising instructions to:
identify an area within the location based on the eye gaze of the user; and
send instructions to the autonomous robotic device to navigate to the identified area and perform an operation at the identified area.

8. The system of claim 7, wherein the location indicator device is an augmented reality device that displays a perimeter of the identified area.

9. The system of claim 8, wherein the perimeter is adjustable based on the eye gaze of the user.

10. The system of claim 8, wherein the augmented reality device displays device information of the autonomous robotic device.

11. The system of claim 7, wherein the instructions to navigate to the identified area override navigation instructions of the autonomous robotic device.

12. The system of claim 7, wherein the instructions to identify the area include instructions to:
determine an angle between the location indicator device and the area within the location; and
determine an angle between the location indicator device and a current location of the autonomous robot device.

13. A moveable robotic device, comprising:
a docking interface to couple a location indicator device to a surface of the moveable robotic device, wherein the docking interface provides electrical power to the location indicator;
a controller, comprising instructions to:
determine when the location indicator device is removed from the docking interface;
provide device information to the location indicator device;
determine a navigation path for a location;
receive an identified area from the location indicator device; and
alter the navigation path to prioritize the identified area.

14. The moveable robotic device of claim 13, wherein the controller includes instructions to identify obstacles between a current location of the moveable robotic device and the identified area.

15. The moveable robotic device of claim 13, wherein the identified area includes a portion of the location defined by a perimeter.
